(19) United States
(12) Patent Application Publication
(10) Pub. No.: US 2005/0133977 A1
(43) Pub. Date: Jun. 23, 2005

(54) Chair

(76) Inventor: Steve Lee, Chicago, IL (US)

Correspondence Address: Kevin D. Erickson;Pauley Petersen & Erickson, Suite 365, 2800 West Higgins Road, Hoffman Estates, IL, 60195, US

(21) Appl. No.: 10/744,948

(22) Filed: Dec. 23, 2003

(51) Int. Cl. F16D 55/36

(52) U.S. Cl. 267/131

(57) ABSTRACT

A chair includes a seat portion; a backrest surrounding at least a portion of the seat portion; and a base removably positioned beneath the seat portion. The base preferably includes tapered sidewalls that correspond with the backrest when the base is inverted and placed on the seat portion. In such a nested position, the disassembled chair may be efficiently shipped and stored in polyhedral boxes with angled side walls, that may be stacked and alternatingly inverted to take advantage of the angled sidewalls of such boxes.

### BACKGROUND OF THE INVENTION

1. Field of the Invention

This invention relates to a chair that includes a base that is inverted and nestable within a seat to provide a compact package for storage and shipping.

2. Description of Related Art

Chairs are typically bulky and difficult to ship and store. A need exists for a chair that may be disassembled to form an efficient package for storing and shipment.

### SUMMARY OF THE INVENTION

It is one object of this invention to provide a chair that may be disassembled to nest a base in an inverted manner in a seat portion of the chair.

It is another object of this invention to provide a chair having a base with tapered sidewalls that correspond with a taper of a backrest of the chair.

It is still another object of this invention to provide a chair that may be easily shipped and stored to take advantage of the efficiencies of having a base nested within a seat portion.

According to a preferred embodiment of this invention, a chair includes a seat portion, a backrest and a base. The backrest preferably surrounds at least a portion of the seat portion and may include a plurality of upwardly and outwardly extending members. The base is preferably removably positioned beneath the seat portion using a threaded channel positioned off-center relative to a center of a bottom of the seat portion. A fastener connects the base to the threaded channel and thus the seat portion.

The base preferably includes tapered sidewalls and generally forms a conic section. Such tapered sidewalls preferably inversely correspond with a taper of the backrest so that the base may be inverted and placed on the seat portion. As a result of nesting the base within the seat portion and the backrest, the chair may be packaged, stored and shipped in an efficient manner.

### BRIEF DESCRIPTION OF THE DRAWINGS

The drawings show a chair, according to preferred embodiments of this invention, wherein:

FIG. 1 is a front view of a chair, according to one preferred embodiment of this invention;

FIG. 2 is a top view of the chair, as shown in FIG. 1;

FIG. 3 is a back view of the chair, as shown in FIG. 1;

FIG. 4 is a bottom view of the chair, as shown in FIG. 1;

FIG. 5 is a bottom view of the chair with a base of the chair detached, according to one preferred embodiment of this invention;

FIG. 6 is a front view of the chair, as shown in FIG. 5, with the base positioned in a seat of the chair, according to one preferred embodiment of this invention; and

FIG. 7 is a front view of a carton for shipping and storing the chair, as shown in FIG. 1.

### DETAILED DESCRIPTION OF THE PREFERRED EMBODIMENTS

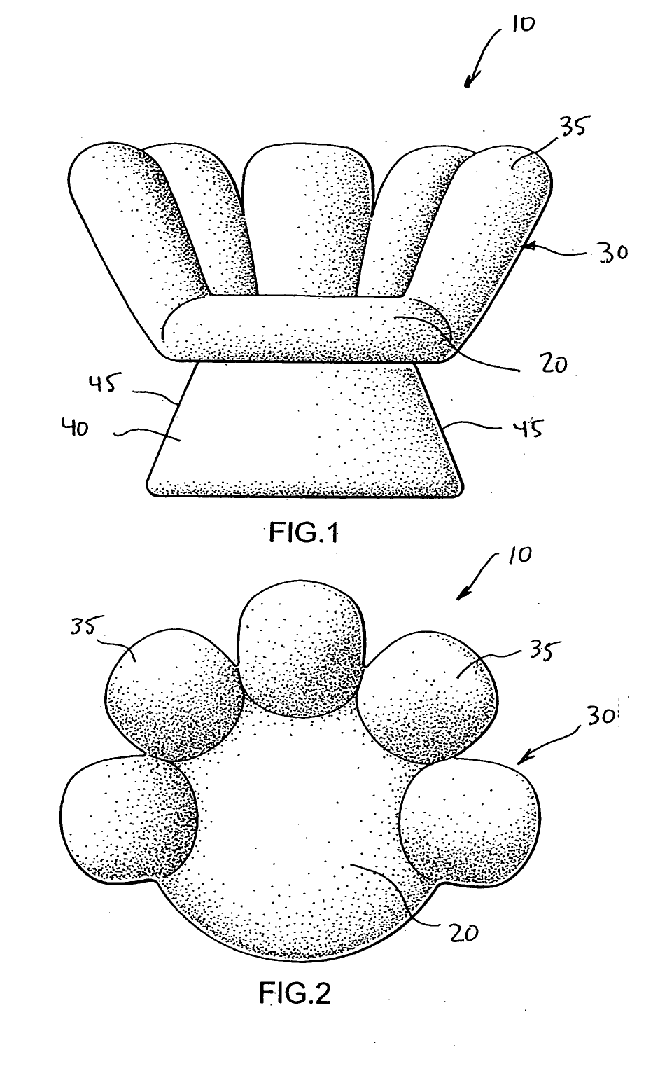

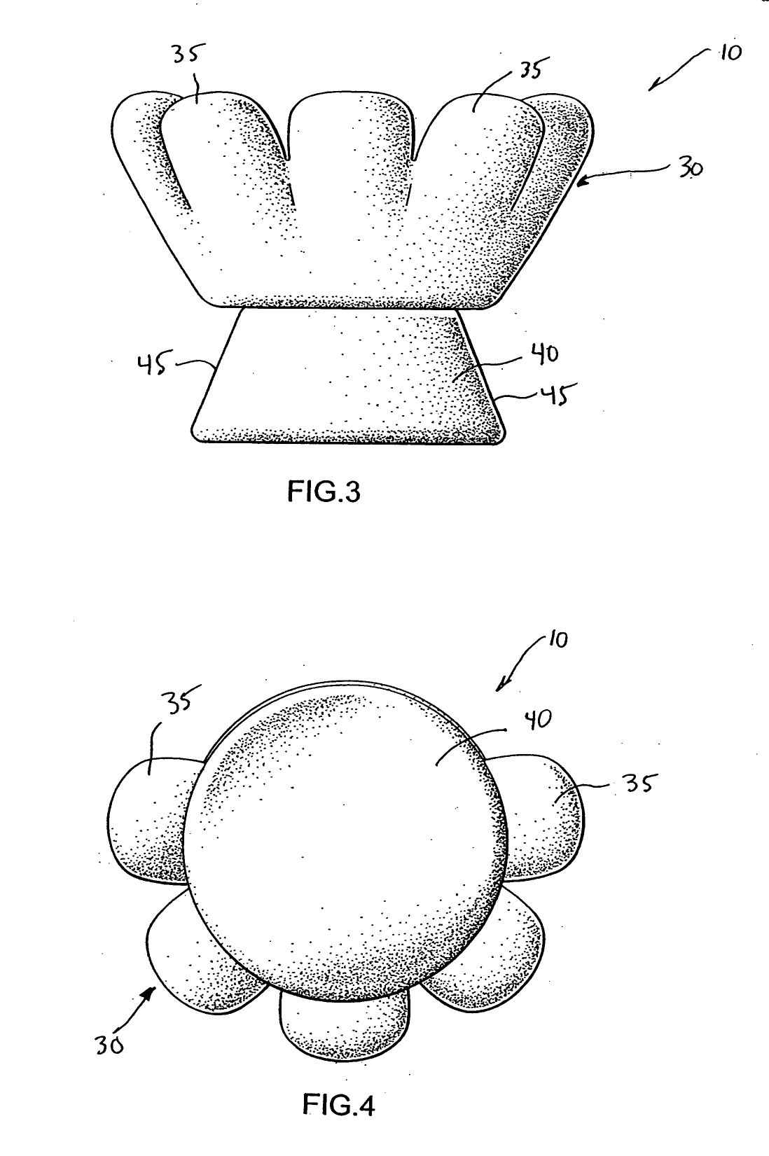

FIGS. 1-6 show various views and embodiments of chair 10 according to preferred embodiments of this invention. As shown in FIG. 1, chair 10 preferably includes seat portion 20, backrest 30 and base 40.

Backrest 30 preferably surrounds at least a portion of seat portion 20. As shown in the figures, backrest 30 preferably comprises a plurality of upwardly and outwardly extending members 35 arranged at least partially around a perimeter of seat portion 20. Such upwardly and outwardly extending members 35 preferably include an outward taper as members 35 extend upward.8. Seat portion 20 is preferably generally circular and backrest 30 preferably surrounds at least 40% of a circumference of seat portion 20.

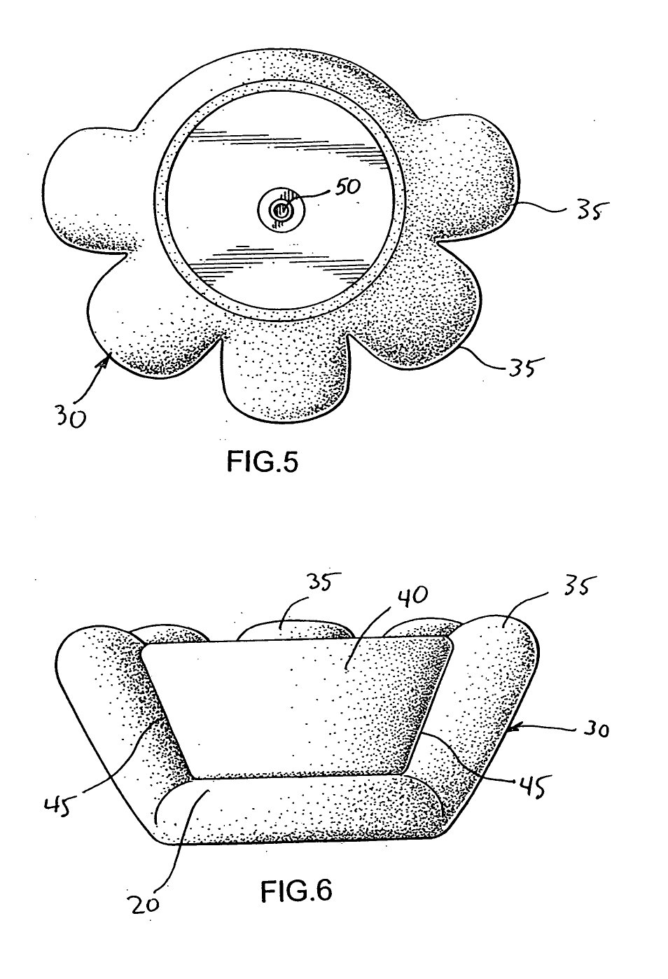

According to a preferred embodiment of this invention, base 40 is removably positioned beneath seat portion 20. Preferably, base 40 is removably attached to seat portion 20 with threaded channel 50 within a bottom of seat portion 20 as shown in FIG. 5. Threaded channel 50 is preferably positioned off-center relative to a center of the bottom of seat portion 20 and, more specifically, closer to a backrest side of the bottom of seat portion 20 as shown in FIG. 5. A fastener (not shown), such as a threaded fastener is then used to connect base 40 to threaded channel 50 and thus seat portion 20. As a result of the off-center connection within seat portion 20, a center of gravity of the occupied chair is preferably biased directly over base 40 thereby preventing a user of chair 10 from tipping over backwards or forwards.

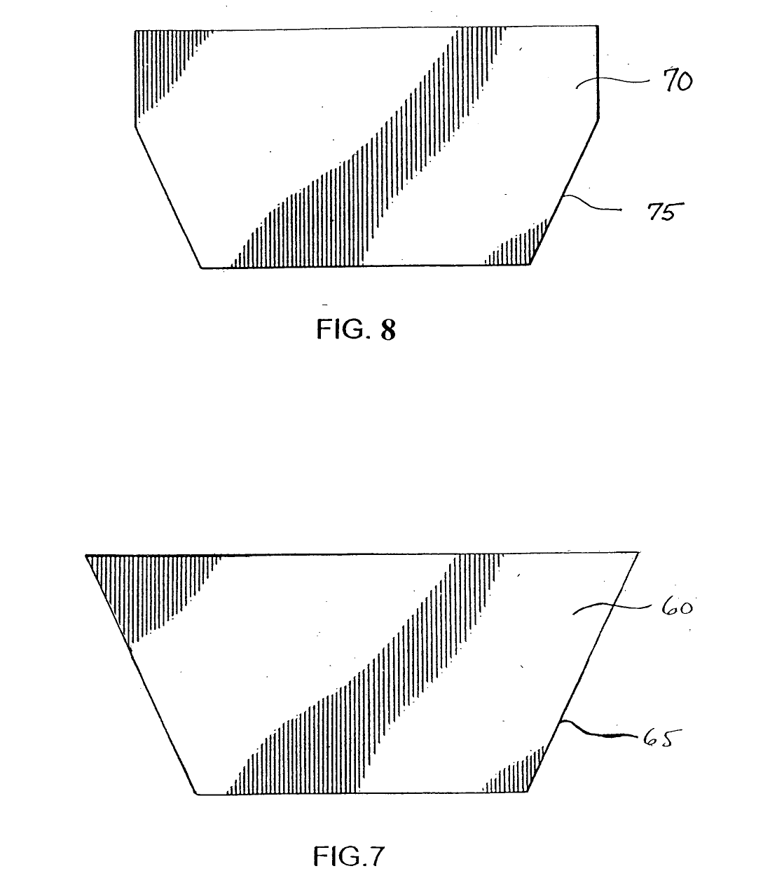

As shown in FIG. 1, base 40 preferably includes tapered sidewalls 45 and generally forms a conic section. Such tapered sidewalls 45 preferably inversely correspond with a taper of backrest 30 so that base 40 may be inverted and placed on seat portion 20. As shown in FIG. 6, base 40 may be inverted and nested within seat portion 20 so that a bottom of base 40 is generally flush with a top of backrest 30. More preferably, in a nested position, base 40 is entirely contained within a boundary defined by backrest 30 and seat portion 20.

As a result of nesting base 40 within seat portion 20 and backrest 30, chair 10 may be packaged, stored and shipped in an efficient manner. Seat portion 20 containing base 40 may be packaged into a trapezoidal box 60, as shown in FIG. 7, so that an outer taper of backrest 30 generally corresponds with sidewall 65 of the trapezoidal box 60. A group of chairs 10 may thus be shipped and stored in a corresponding group of trapezoidal boxes 60 that may be arranged so that each trapezoidal box 60 is inverted relative to each adjacent other trapezoidal box 60. Accordingly a large group of boxes 60 may be stored in a smaller area than a rectangular box by taking advantage of inverted adjacent boxes 60.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A chair comprising:
a seat portion;
a backrest protruding outwardly and upwardly at a taper from the seat portion and surrounding at least a portion of the seat portion; and
a base removably positionable beneath the seat portion, the base having tapered sidewalls that correspond with the taper of the backrest, such that the base is capable of being inverted and placed on the seat portion in a nested position whereby the base is supported by the backrest and the seat portion.

2. The chair of claim 1 further comprising:
a threaded channel positioned off-center within a bottom of the seat portion; and
a fastener for connecting the base to the threaded channel.

3. The chair of claim 1 wherein the backrest comprises a plurality of upwardly and outwardly extending members arranged at least partially around a perimeter of the seat portion.

4. (canceled)

5. The chair of claim 3 wherein the base is threadedly attachable with the seat portion through a threaded channel positioned off-center in a bottom of the seat portion.

6. The chair of claim 1 wherein, the base is sized so as when placed in the nested position, a bottom of the base is generally flush with a top of the backrest.

7. The chair of claim 1 wherein, in the nested position, the base is sized so as to be entirely contained within a boundary defined by the backrest and the seat portion.

8. The chair of claim 1 wherein the seat portion is generally circular and the backrest surrounds at least 40% of a circumference of the seat portion.

9. The chair of claim 1 wherein the base comprises a conic section.

10. A chair comprising:
a seat portion;
a backrest including a plurality of members extending upwardly and outwardly at a taper from the seat portion and arranged at least partially around a perimeter of the seat portion;
a base removably positioned beneath the seat portion, the base having tapered sidewalls that correspond with the taper of the plurality of upwardly and outwardly extending members such that the base is capable of being inverted on the seat portion in a nested position whereby the base is supported by the backrest and the seat portion; and
whereby the base, backrest and seat portion when placed in the nested position will nest within a polyhedral box having tapered sidewalls such that an outer taper of the backrest corresponds with the taper of a sidewall of the polyhedral box.

11. The chair of claim 10 further comprising:
a threaded channel positioned off-center within a bottom of the seat portion; and
a fastener for connecting the base to the threaded channel.

12. The chair of claim 10 wherein, in the nested position, a bottom of the base is generally flush with a top of the backrest.

13. The chair of claim 10 wherein the backrest further comprises:
five or more members arranged partially around the perimeter of the seat portion.

14. The chair of claim 10 wherein the base comprises a conic section.

15. A method of packaging a chair comprising:
nesting a base of the chair into a seat portion of the chair in an inverted position, the base having tapered sidewalls that correspond with an inner surface of a backrest of the seat portion; and
placing the nested base and seat portion into a polyhedral box having tapered sidewalls, the backrest having an outer surface with an outward taper corresponding with a sidewall taper of the polyhedral box.

16. The method of packaging a chair according to claim 15 further comprising:
arranging the polyhedral box relative to adjacent polyhedral boxes so that each polyhedral box is inverted relative to each other polyhedral box such that adjacent boxes have overlapping tapered sides.

17. A chair comprising:
a seat portion;
a backrest protruding outwardly and upwardly at an angle from the seat portion and surrounding at least a portion of the seat portion; and
a base in a first nested position within the backrest and seat portion, whereby the base is contained and supported by the backrest and the seat portion, the base having tapered sidewalls with a taper angle of the sidewalls being substantially equal to the protruding angle of the backrest; and
the base being capable of being inverted to a second position and attached to and beneath the seat portion, thereby forming a chair.

18. The chair of claim 17 further comprising:
the base being contained within a boundary defined by the backrest and the seat portion.

19. The chair of claim 17 further comprising:
the nested base, backrest, and seat portion being nested in a polyhedral box with tapered sidewalls.
